(19) United States
(12) Patent Application Publication
(10) Pub. No.: US 2004/0160985 A1
(43) Pub. Date: Aug. 19, 2004

(54) System and method for network address translation and session management

(76) Inventor: Sung-Woon Kang, Yongin-city (KR)

Correspondence Address: Robert E. Bushnell, Suite 300, 1522 K Street, N.W., Washington, DC, 20005, US

(21) Appl. No.: 10/757,486

(22) Filed: Jan. 15, 2004

(30) Foreign Application Priority Data
Feb. 14, 2003 (KR) 2003-9512

(51) Int. Cl. H04J 3/24

(52) U.S. Cl. 370/475

(57) ABSTRACT

A system and method for network address translation (NAT) and session management, is for performing address translation and distributing a call to a plurality of call agents with respect to a SIP(Session Initiation Protocol) message in an NAT system, by applying NAT concept to a SIP call initiated at the external public network or the local network. The system and method for network address translation (NAT) and session management includes a plurality of call agents (constituting the local network), interfacing a plurality of the SIP call agents with the NAT block, controlling the NAT block to uniformly distribute a SIP call input from the outside, to the internal SIP call agent. Also, the system and method for network address translation (NAT) and session management, could include more than one call agent for a packet exchange system, by applying the NAT using the SIP to a packet exchange system for supporting VoIP using the SIP in the packet network, and thus much more traffic could be processed.

### CLAIM OF PRIORITY

This application makes reference to, incorporates the same herein, and claims all benefits accruing under 35 U.S.C. § 119 from an application for SYSTEM AND METHOD FOR CONTROLLING NETWORK ADDRESS TRANSLATION AND SESSION earlier filed in the Korean Intellectual Property Office on 14 Feb. 2003 and there duly assigned Serial No. 2003-9512.

### BACKGROUND OF THE INVENTION

1. Field of the Invention

The present invention relates to a system and method for the NAT (Network Address Translation) and a session management, for performing address translation and distributing a call to a plurality of call agents with respect to a SIP (Session Initiation Protocol) message in an NAT system, by applying NAT concept to a SIP call initiated at the external public network or the local network in a packet exchange system for processing a SIP call.

2. Description of the Related Art

Up to now, the Internet has been developing mainly in the field of data traffic such as an e-mail (electronic mail) or web and with the advent of application requiring transfer of real-time traffic such as distant learning, teleconference, the Internet is now progressing to the trend of accepting the real time traffic such as voice and image.

Transmission of audio and video data is performed with use of a UDP (User Datagram Protocol) or IP multicast, not a reliable transport protocol such as a TCP (Transport Control Protocol), for real-time transport to a plurality of attendants.

H.323 protocol is the “Packet-based Multimedia Communication Systems” and is the standard recommendations of a video conference system for a variety of packet exchange networks represented by the Internet

The H.323 system does not retransmit a damaged or lost packet upon transmission, but instead, uses a method of dynamically controlling transmission rate or of recovering the packet lost during the conference by monitoring lost data, thereby putting an emphasis on real-time property rather than reliability.

In the meantime, the SIP (Session Initiation Protocol) system operating on the basis of the IP (Internet Protocol) consists of a user agent and a network server. The user agent is a terminal, performing the same function as the terminal of the H.323, and generally functioning as a UAC (User Agent Client) for requesting a call and a UAS (User Agent Server) for responding to a requested call.

The SIP makes use of the existing Internet servers such as the existing Name Server, Authentication server as they are, referring to overall procedures regarding a call session establishment, maintenance, release, management for the Internet phone. The SIP is a protocol based on a client-server, and develops in such form that a call trying part calls a counterpart in order to get the counterpart to attend a session. Therefore, the SIP provides functions such as a user position locating, session establishing, session negotiating, session participant managing and a Call Feature Invocation including Hold, Transfer, Mute. Also, for processing a call, the SIP uses a protocol based on a text having syntax and semantics similar to HTTP (Hyper Text Transfer Protocol).

In the NAT system applying the SIP of the related art, a call agent, which is one SIP call controller, plays a role of mediating a call between a calling SIP terminal and a called SIP terminal.

Therefore, SIP traffic swiftly processed by one SIP call agent is limited and if many SIP calls are tried simultaneously to one call agent, traffic processed by the call agent become limited even more, so that swift processing of a SIP call gets difficult.

In order to resolve such problem, a NAT system having a plurality of SIP call agents for processing much more SIP traffic simultaneously, for distributing a call to a plurality of these SIP call agents, is required.

The NAT system performs a function of translating a network address. Namely, the NAT system transmits an IP packet received from the public network, to the local network, translating a network address in order to transmit the IP packet received from the local network, to the public network.

By such function, the Internet could be accessed at a node where an individual address is not assigned. Also, specific TCP/IP (Transfer Control Protocol/Internet Protocol) application could be used through translation for protocol of TCP/IP transmission layer or application layer.

### SUMMARY OF THE INVENTION

It is, therefore, an object of the present invention to provide a system and method for address translation and session management in a network address translation system capable of performing address translation and swiftly distributing a call to a plurality of call agents with respect to a SIP message in the NAT system, applying NAT concept to a SIP call initiated at the external public network or the local network in a packet switching system for processing a SIP call.

It is another object of the present invention to provide a system and method for network address translation and session management according to the present invention, that could include more than one call agent for a packet exchange system, by applying the NAT using the SIP to a packet exchange system for supporting VoIP(Voice over Internet Protocol) using the SIP in the packet network, and thus processing much more traffic.

It is yet another object to provide a system and method for network address translation and session management according to the present invention that gives a private network address to the call agents in the local network, giving a public network address to the NAT, thereby properly distributing the SIP call input to the NAT from the external network, to the call agents in a plurality of local networks.

It is still another object to provide one call agent connected through the first Call ID processes a call from its beginning to its ending, so that the call agents in the local network could process much more calls.

It is another object to provide a system and method for address translation and session management in a network address translation system capable of easy and inexpensive implementation while having increased efficiency.

To achieve the above and other objects, the present invention includes a plurality of call agents (constituting the local network) and interfacing a plurality of SIP call agents with the NAT. This NAT uniformly distributes a SIP call input from the outside, to the SIP call agents in its inside.

Namely, one aspect of a “system for network address translation and session management” of the present invention to achieve the above object, includes: a calling SIP terminal connected to an external public network; a network address translation block (NAT block) for receiving a SIP message transmitted from the calling SIP terminal, performing address translation and session management for the calling SIP terminal of an internal SIP; a plurality of call agents constituting a local network with the NAT block, for being responsible for call process.

Another aspect of a “system for network address translation and session management” of the present invention, includes: a plurality of call agents responsible for call process; a network address translation block (NAT block) connected to a plurality of the call agents through a local network, for performing address translation and session management for a SIP message received from the call agents existing in a local network by interfacing an external network; a called SIP terminal connected to the NAT block and an external public network.

In the meantime, one aspect of a “method for network address translation and session management” of the present invention, includes: receiving a call establishment request message generated from a calling SIP terminal connected to an external public network, extracting a public network address from the received call establishment request message, storing the same; selecting a specific call agent among a plurality of call agents, storing a communication path for the specific call agent in session information of a relevant call after the above step; and distributing traffic by transmitting a SIP message transmitted from the calling SIP terminal, to a selected call agent only, using information stored in a session of the relevant call.

Selection of a specific call agent in the above, is made by selecting different one call agent among a plurality of call agents for a call establishment request message generated from a calling SIP terminal.

Also, aspect of a “method for network address translation and session management” of the present invention, includes: receiving a call establishment request message generated from a plurality of call agents connected through a local network, extracting a public network address from the received call establishment request message, storing the same; storing a communication path for a specific call agent among a plurality of call agents in session information of a relevant call after the above step; and distributing traffic by transmitting a SIP message transmitted from the specific call agent, to a selected calling SIP terminal only, using information stored in a session of the relevant call. Here, the calling SIP terminal transmits and receives a SIP message only through a different one call agent among a plurality of call agents.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a drawing showing procedure for a SIP call process upon call mediation by a call agent (SIP proxy server) in the NAT system;

FIG. 2 is a drawing showing procedure for a call process in case that a call originates from a SIP client in a system and method for network address translation and session management according to the present invention; and

FIG. 3 is a drawing showing procedure for a call process in case that a call terminates to a SIP client in a system and method for network address translation and session management according to the present invention.

### DETAILED DESCRIPTION OF THE PREFERRED EMBODIMENTS

A preferred embodiment of a system and method thereof for network address translation and session management according to the present invention will now be described with reference to the accompanying drawings. The matters defined in the description such as a detailed construction and elements are no more than providing to assist in a comprehensive understanding of the invention. Thus, it is apparent that the present invention can be carried out without those defined matters. Also, well-known finctions or constructions are not described in detail since they would obscure the invention in unnecessary detail.

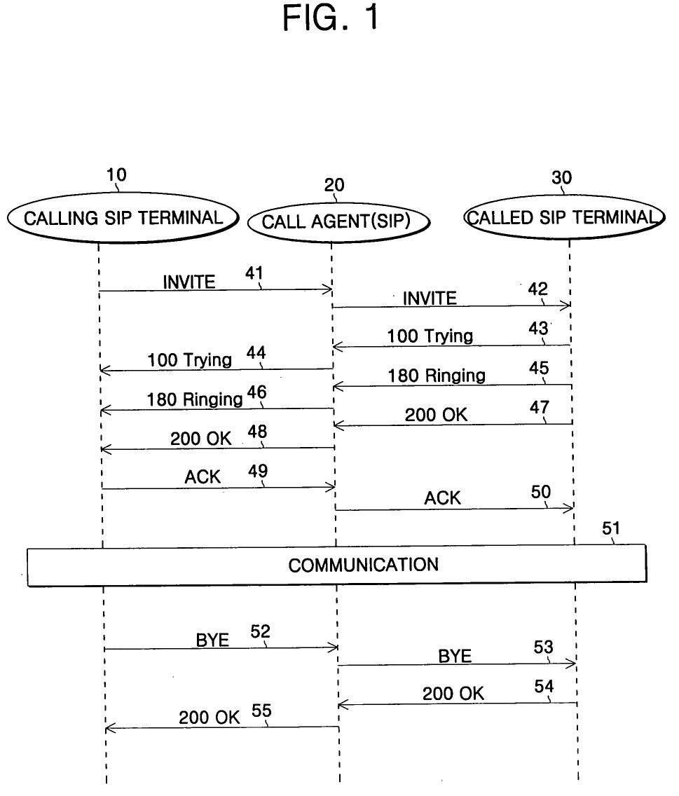

FIG. 1 is a drawing showing procedure for a SIP call process upon call mediation by a call agent (SIP proxy server) in the NAT system.

As shown in FIG. 1, a call agent 20, which is one SIP call controller, plays a role of mediating a call between a calling SIP terminal 10 and a called SIP terminal 30.

A procedure of a call process upon mediation of a call will be described. If a calling SIP terminal 10 transmits a communication request message (INVITE) to a call agent 20 (step 41), a call agent 20 that receives a communication request message transmits the received communication request message(INVITE) to a called SIP terminal 30 (step 42).

Subsequently, the called SIP terminal 30 transmits a message (100 Trying) for informing the processing of a call, to the call agent 20 (step 43), and the call agent 20 which receives that message transmits a processing message for a call, to the calling SIP terminal 10 (step 44).

Also, the called SIP terminal 30 transmits a calling signal (180 Ringing) to the call agent 20(step 45) and the call agent 20 transmits a calling signal to the calling SIP terminal 10 (step 46).

After that, the called SIP terminal 30 transmits a message (200 OK) for accepting a call establishment request, to a call agent 20 (step 47) and the call agent 20 transmits a message(200 OK) for accepting a call establishment request to the calling SIP terminal 10 (step 48).

Subsequently, the calling SIP terminal 10 delivers an acknowledgement message ACK with respect to the response, to the call agent 20 (step 49), and the call agent 20 delivers an acknowledgement message ACK with respect to the response, to the called SIP terminal 30, so that a call is established (step 50).

Subsequently, the calling SIP terminal 10 and the called SIP terminal 30 performs a communication (step 51).

After that, if communication is terminated, the calling SIP terminal 10 delivers a message BYE for requesting connection termination, to the call agent (step 52), and the call agent 20 delivers a message BYE for requesting connection termination, to the called SIP terminal 30 (step 53).

Then, the called SIP terminal 30 transmits a message (200 OK) for accepting connection termination, to the call agent 20 (step 54), and the call agent 20 transmits a message (200 OK) for accepting connection termination, to the calling SIP terminal 10, so that communication is terminated (step 55).

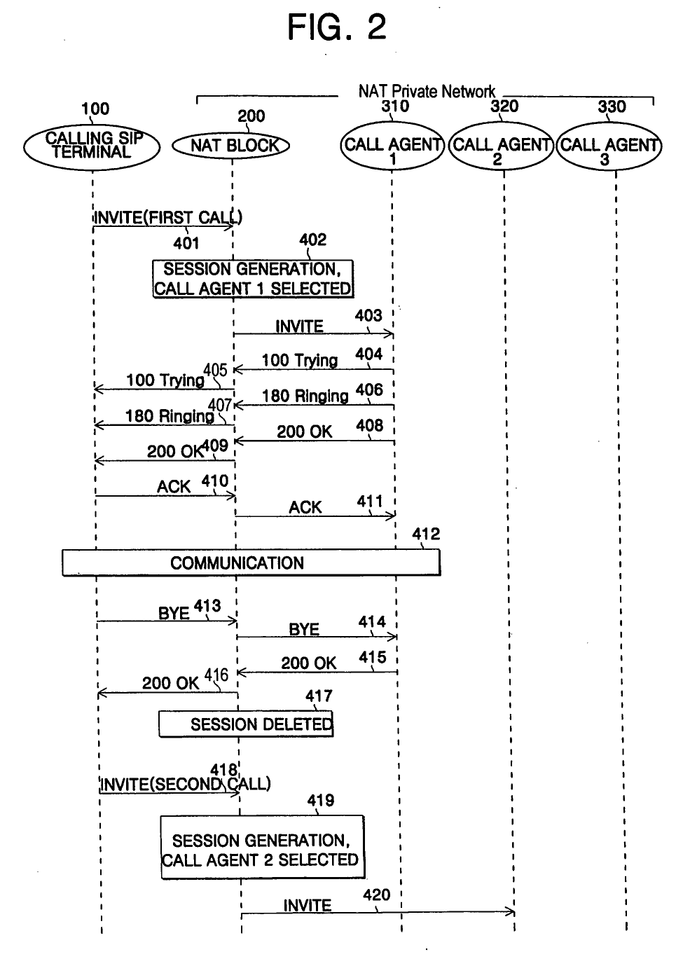

FIG. 2 is a drawing for one embodiment of a method for network address translation and session management according to the present invention, showing procedure for a call process in case that a call originates from a calling SIP terminal. Here, a reference numeral 100 stands for a calling SIP terminal connected to the external public network, a reference numeral 200 stands for the NAT block for receiving a SIP message transmitted from the calling SIP terminal 100, and performing address translation and session management for the calling SIP terminal in the internal SIP, and reference numerals 310 through 330 stand for a plurality of call agents constituting the local network with the NAT block 200, for being responsible for the call process.

On the first place, as shown in FIG. 2, the steps 401 through 402 of receiving a call establishment request message generated from a calling SIP terminal 100 connected to the external is public network, extracting a public network address from the received call establishment request message, storing the same, selecting a specific call agent among a plurality of call agents, storing a communication path for the specific call agent in session information of the relevant call, and the step 403 of distributing traffic by transmitting a SIP message transmitted from the calling SIP terminal 100, to the selected call agent only, using information stored in session of the relevant call, and the general steps 404 through 416 of processing a SIP call, and the step 417 of deleting session if the first call process is completed, and the steps 418 through 420 of, if the second call establishment request message is received, extracting a public network address from the received call establishment request, storing the same, selecting a specific call agent among a plurality of call agents, storing a communication path for the specific call agent in session information of the relevant call, distributing traffic by transmitting a SIP message transmitted from the calling SIP terminal 100, to the selected call agent only, using information stored in session of the relevant call, are provided.

Call process operation in the NAT block 200 upon originating of a call from the calling SIP terminal 100 of the present invention having the foregoing construction will be described in more detail as follows.

The SIP terminal 100 connected to the external public network puts a public network address of the terminal into “via” and “Contact” fields of an INVITE message, transmitting the same to the NAT block 200 (step 401).

The NAT block 200 which receives the INVITE message judges the beginning of a call, generating one session for a call using a “CallID” (call identification) value. Also, the NAT block 200 stores, in the relevant session, a public network address and a UDP port of the calling SIP terminal 100 in order to give a response to the external calling SIP terminal 100.

If the public network address and the UDP port are stored, one call agent (e.g., 310) among a plurality of call agents 310, 320, 330 constituting the local network is selected and address information for the selected call agent is stored in the generated session (step 402) and the relevant message is transmitted to the selected call agent 310 (step 403).

Subsequently, the selected call agent 310 transmits a “100 Trying” message informing a process for a call, to the NAT block 200 (step 404), and the NAT block 200 transmits a “100 Trying” message to the public network address and the UDP port of the external calling SIP terminal 100 stored in the generated session(step 405).

As the steps 406 through 412 after that, are the same as the process procedure of the related art shown in FIG. 1, description thereof will be omitted.

Namely, in the steps 406 through 412, session of the relevant call is searched with use of “CallID” for all the messages transmitted from the calling SIP terminal 100, and a call agent stored in the session is searched and all the SIP messages are transmitted to the call agent 310 selected upon beginning of a call.

If the calling SIP terminal 100 transmits a “BYE” message to release a call after a call is completed (step 413), the NAT block 200 searches a call agent 310 stored in the session of the relevant call, informs the call agent 310 of a call release request (step 414), receives a “200 OK”, which is a response thereto, from the call agent (step 415), and transmits the same (“200 OK”) to the calling SIP terminal 100 (step 416).

After that, the session where all information for the relevant call is stored, is deleted (step 417).

If the NAT block 200 receives an “INVITE” message of the second call after the first call is terminated (step 418), the NAT block 200 selects a new call agent 320 for uniform distribution of a call (step 419), processing the relevant call by transmitting the “INVITE” message to the selected call agent 320, (step 420).

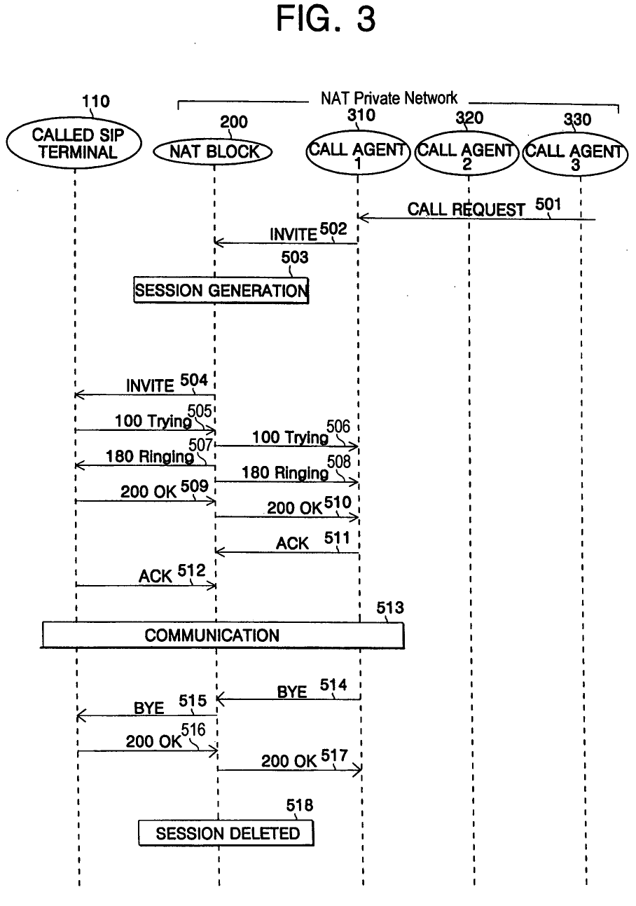

FIG. 3 is a drawing for another embodiment of a method for network address translation and session management according to the present invention, showing procedure for a call process in case that a call terminates to a called SIP terminal.

Here, reference numerals 310,320,330 stand for a plurality of call agents responsible for call process, and the NAT block represented by a reference numeral 200 is connected to a plurality of the call agents 310,320,330 through the local network.

Also, a reference numeral 200 stands for the NAT block for performing address translation and session management for a SIP message received from the call agents 310,320,330 existing in the local network by interfacing the external network, and a reference numeral 110 is connected to the NAT block, and stands for a called SIP terminal connected to the external public network.

In the above, the called SIP terminal 110 is actually the same as the calling SIP terminal, 100 in FIG. 2 and different reference numeral and terminology are used for discriminating between a call originating operation and a call terminating operation.

In the first place, the call agents 310,320,330 in the called side inserts a local private network address of the relevant call agent (e.g. a call agent corresponding to 310), “Via” field and “Contact” field of an INVITE message in order to initiate a terminated SIP call, transmitting the same to the NAT block 200 (step 501-step 502).

The NAT block 200 which receives the INVITE message, generates session for the relevant call using “CallID”, and changes the local private network address of the “Via” field and the “Contact” field within the “INVITE” message, into a public network address of the NAT block 200 (step 503).

Subsequently, the NAT block 200 transmits an “INVITE” message to the called SIP terminal 110 of the external public network, storing, in the relevant session, address information of the call agent 310 that transmits the local private network address and the “INVITE” message (step 504).

In response to a “100 Trying” message received from a Session Initiation Protocol (SIP) terminal 110, the NAT block 200 changes “Nia” and “Contact” fields into the local private network address, which is stored in the session upon receipt of “INVITE” message from the call agent 310 in step 502, and transmits the “100” message to the call agent 310 stored in the session.

After that, the step 507 through step 513 are the same as the call process procedure of the related art shown in FIG. 1, so that detailed description thereof will be omitted.

Namely, the steps 507 through 513 change all the messages transmitted from the external called SIP terminal 110, into the public network address of the NAT block 200, and transmitting the same.

If the call agent 310 transmits a “BYE” message to the NAT block 200 in order to release a call after a call is completed (step 514), the NAT block 200 changes the local private network address within the “BYE” message, into the public network address of the NAT block 200, transmitting the same to the called SIP terminal 110 (step 515).

The called SIP terminal 110 which receives the “BYE” message, informs the NAT block of a normal call release by transmitting a “200 OK” message to the NAT block 200 (step 516), and the NAT block which receives the “200 OK” message, transmits the “200 OK” message to the call agent 310 stored in the relevant session (step 517), deleting all information and session for the relevant call (step 518).

The present invention can be realized as computer-executable instructions stored in computer-readable media. The computer-readable media includes all possible kinds of recording media in which computer-readable data is stored. The computer-readable media include storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), system memory (read-only memory, random access memory), flash memory, and carrier waves (e.g., transmission via the Internet). Also, the computer-readable media can store and execute computer-readable codes that are distributed in computers connected via a network.

As is apparent from the foregoing, the system and method for network address translation and session management according to the present invention, could include more than one call agent for a packet exchange system, by applying the NAT using the SIP to a packet exchange system for supporting VoIP (Voice over Internet Protocol) using the SIP in the packet network, and thus much more traffic could be processed compared to the method of the related art.

Also, the system and method for network address translation and session management according to the present invention gives a private network address to the call agents in the local network, giving a public network address to the NAT, thereby properly distributing the SIP call input to the NAT from the external network, to the call agents in a plurality of local networks.

Also, one call agent connected through the first Call ID processes a call from its beginning to its ending, so that the call agents in the local network could process much more calls.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A system for network address translation and session management comprising:
a calling terminal connected to an external network;
a network address translation block for receiving a session initiation protocol message transmitted from the calling terminal, performing address translation and session management for the calling terminal of an internal session initiation protocol; and
a plurality of call agents constituting a local network with the network address translation block, for being responsible for a call process.

2. The system according to claim 1, wherein the network address translation block translates a public network address transmitted from the calling terminal, into a local network address, connecting to a plurality of call agents.

3. The system according to claim 1, wherein the network address translation block interfaces a call by selecting one call agent among a plurality of the call agents for one “INVITE” message which is a call establishment request message generated from the calling terminal.

4. A system for network address translation and session management comprising:
a plurality of call agents responsible for a call process;
a network address translation block connected to a plurality of the call agents through a local network, for performing address translation and session management for a session initiation protocol message received from the call agents existing in the local network by interfacing an external network; and
a called terminal connected to the network address translation block and an external network.

5. The system according to claim 4, wherein the network address translation block connects to the called terminal by translating a local network address transmitted from a plurality of the call agents, into a public network address.

6. The system according to claim 4, wherein the network address translation block interfaces a call between the called terminals corresponding to one “CallID” by analyzing an “INVITE” message generated from the call agents.

7. A method for sending a call, at a calling terminal, in a system for network address translation and session management, the method comprising the steps of:
receiving, at a network address translation block provided between the calling terminal and call agents, a call establishment request message generated from the calling terminal connected to an external network, extracting a public network address from the received call establishment request message, storing the public network address;
selecting a specific call agent among a plurality of the call agents, storing a communication path for the specific call agent in session information of a relevant call; and
distributing traffic by transmitting a session initiation protocol message transmitted from the calling terminal, to a selected call agent only, using information stored in a session of the relevant call.

8. The method according to claim 7, wherein selection of the specific call agent in the above, is made by selecting different one call agent among a plurality of the call agents for a call establishment request message generated from a calling terminal.

9. The method according to claim 7, wherein the network address translation block at the receiving step, performs the step of judging a beginning of a call when a call establishment request message generated from the calling terminal connected to the external public network is received; generating one session for a call using a “CallID” value, storing a public network address and a UDP(User Datagram Protocol) port of the calling terminal; and selecting one call agent among a plurality of the call agents constituting a local network, storing an address of that selected call agent in the generated session, then transmitting a session initiation protocol message to the selected call agent.

10. The method according to claim 7, wherein the network address translation block in the receiving step, further performs the step of deleting session in which all information for a relevant call is stored when the relevant call is completed.

11. The method according to claim 7, wherein the network address translation block at the receiving step, performs the step of selecting a new call agent for uniform distribution of a call when an “INVITE” message of a second call is received after a first call is terminated, processing a relevant call by transmitting the “INVITE” message to the newly selected call agent.

12. The method according to claim 7, with the storing of the communication path for the specific call agent in session information of the relevant call after the step of receiving the call establishment request message, extracting the public network address and storing the public network address.

13. A method for receiving a call, at a called terminal, in a system for network address translation and session management, the method comprising the steps of:
receiving, at a network address translation block provided between the called terminal and call agents, a call establishment request message generated from a plurality of the call agents connected through a local network, extracting a public network address from the received call establishment request message, storing the public network address;
storing a communication path for a specific call agent among a plurality of the call agents in session information of a relevant call; and
distributing traffic by transmitting a session initiation protocol message transmitted from the specific call agent, to a selected calling terminal only, using information stored in a session of the relevant call.

14. The method according to claim 13, wherein the calling terminal at the receiving step, transmits and receives a session initiation protocol message only through different one call agent among a plurality of the call agents.

15. The method according to claim 13, wherein the network address translation block at the receiving step, performs the step of generating session for a relevant call using a “CallID” when an “INVITE” message for initiating a terminated session initiation protocol call is received from call agents in a terminating side;
changing a local private network address of a “Via” field and a “Contact” field and a “Contact” field within the “INVITE” message, into a public network address, transmitting the “INVITE” message to the terminal of the public network; and
storing, in a relevant session, address information of a call agent which transmits the local private network address and the “INVITE” message.

16. The method according to claim 13, wherein the network address translation block at the receiving step, performs the step of, when a call agent receives a “BYE” message transmitted for releasing a call after a call is completed, changing a local private network address within the “BYE” message, into a public network address, transmitting the public network address to the called terminal.

17. The method according to claim 13, wherein the network address translation block at the receiving step, further performs the step of deleting the session in which all information for a relevant call is stored when the relevant call is completed.

18. The method according to claim 13, with the storing of the communication path for the specific call agent in session information of the relevant call after the step of receiving the call establishment request message, extracting the public network address and storing the public network address.

19. A computer-readable medium having computer-executable instructions for performing a method, comprising:
receiving, at a network address translation block provided between a calling terminal and call agents, a call establishment request message generated from the calling terminal connected to an external network, extracting a public network address from the received call establishment request message, storing the public network address;
selecting a specific call agent among a plurality of the call agents, storing a communication path for the specific call agent in session information of a relevant call; and
distributing traffic by transmitting a session initiation protocol message transmitted from the calling terminal, to a selected call agent only, using information stored in a session of the relevant call.
